(19) United States
(12) Patent Application Publication
(10) Pub. No.: US 2008/0300875 A1
(43) Pub. Date: Dec. 4, 2008

(54) Efficient Speech Recognition with Cluster Methods

(75) Inventors: Kaisheng Yao, Bellevue, WA (US); Yu Tsao, Atlanta, GA (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 12/133,197

(22) Filed: Jun. 4, 2008

Related U.S. Application Data
(60) Provisional application No. 60/941,733, filed on Jun. 4, 2007.

(51) Int. Cl. G10L 15/00

(52) U.S. Cl. 704/236; 704/E15.001

(57) ABSTRACT

A speech recognition method and system, the method comprising the steps of providing a speech model, said speech model includes at least a portion of a state of Gaussian, clustering said Gaussian of said speech model to give N clusters of Gaussians, wherein N is an integer and utilizing said Gaussian in recognizing an utterance.

### CROSS-REFERENCE TO RELATED APPLICATIONS

This application claims benefit of U.S. provisional patent application No. 60/941,733, filed June. 4, 2007, which is herein incorporated by reference. The following co-assigned, co-pending patent applications disclose related subject matter: application Ser. Nos. 11/196,601 and 11/195,895, both filed Aug. 3, 2005; Ser. No. 11/289,332, filed Dec. 9, 2005; Ser. No. 11/278,504, filed Apr. 3, 2006; and Ser. No. 11/278,877, filed Apr. 6, 2006, which are herein incorporated by reference.

### BACKGROUND OF THE INVENTION

The present invention relates to digital signal processing, and more particularly to automatic speech recognition.

The last few decades have seen the rising use of hidden Markov models (HMMs) in automatic speech recognition (ASR). For example, single word recognition roughly proceeds as follows: sample input speech (e.g., at 8 kHz); partition the stream of samples into overlapping (windowed) frames (e.g., 160 samples per frame with ⅔ overlap); apply a fast Fourier transform (e.g., 256-point FFT) to each frame of samples to convert to the spectral domain; obtain the spectral energy density in each frame by squared absolute values of the transform; apply a Mel frequency filter bank (e.g., 20 overlapping triangular filters which have linear spacing up to about 1 kHz and logarithmic from 1 kHz to 4 kHz) to the spectral energy density in the Mel subbands and integrate to the linear spectral energy domain for a 20-component vector for each frame; apply a logarithmic compression to convert to the log spectral energy domain; apply a 20-point discrete cosine transform (DCT) to decorrelate the 20-component log spectral vectors to convert to the cepstral domain with Mel frequency cepstral components (MFCC); take the 10 lowest frequency MFCCs as the feature vector for the frame (optionally include the rate of change and/or acceleration of each component to give a 20- or 30-component feature vector with the rate of change and/or acceleration computed from a linear and/or quadratic fit over prior plus succeeding frames); compare the sequence of MFCC feature vectors for the frames to each of a set of HMMs corresponding to a vocabulary of words (or other unit, such as, (mono)phones, biphones, triphones, syllables, etc.) for recognition; and declare recognition of the word corresponding to the model with the highest score where the score for a model is the probability of observing the sequence of MFCC feature vectors for that model.

Note that for word recognition, when the number of words in the vocabulary is small, then each word may have its own model; whereas, when the number of words in the vocabulary is large, then smaller units, such as, monophones or triphones, would typically be used for the models with a corresponding vocabulary of monophones or triphones. Using monophones (minimal distinguishable speech segments) implies a small vocabulary (43 for English) and, thus, avoids the problems of training for a large vocabulary. However, monophone models cannot effectively model context dependence, and consequently, triphone models are commonly used for large vocabularies. A triphone has a center phone with a left (prior) phone and a right (subsequent) phone to essentially provide context dependence.

The models are constructed (i.e., parameters determined) by training with multiple talkers to insure pronunciation variants are included.

As voice interface technology is maturing, it is becoming more important to deploy it to small, embedded, and mobile devices. Using a voice interface on such devices is especially convenient when normal input methods are not available. But it is well-known that acoustic model mismatch often occurs in ASR, even if the models have been carefully trained in a particular environment. The mismatch is caused by frequent change of testing environments, a situation that often occurs in mobile applications. This often results in serious degradation of recognition performance.

To compensate mismatch due to environment distortion, many methods have been proposed. Particularly, model-based approaches, such as, parallel model combination (PMC) and joint compensation of additive and convolutive (transmission channel) distortion (JAC) are able to reduce the mismatch significantly and, therefore, improve ASR robustness.

However, direct use of these methods is computationally expensive because: (1) these methods adapt all of the mean vectors of the acoustic models before ASR (note that the variances of the acoustic models can be separately adjusted with sequential variance adaptation); (2) the adaptation formulas are usually nonlinear; and (3) adaptation requires mapping between the cepstral and log-spectral domains using the discrete cosine transform (DCT) and its inverse.

The computational cost is associated with the above nonlinear adaptation for every mean vector using the costly mapping between cepstral and log-spectral domains. The cost is especially prohibitive on mobile devices, which have limited computational resources.

Moreover, for resource-limited embedded devices, the likelihood evaluations of a HMM-based ASR system may consume more than a third of total computational time. Thus, any decrease in the likelihood evaluations will have an effect on the overall speed of the recognition process.

Likewise, mismatch due to environmental distortion affects discrimination of speech from background noise. Particularly, non-stationary noise could be recognized as speech and recognition performance could be greatly deteriorated. Even worse, a voice activity detector (VAD) may trigger false speech events and confuse the ASR system recognizer causing low performance and high computational costs. Thus, there are problems to improve robustness to non-stationary background noise and find a robust VAD for ASR.

### SUMMARY OF THE INVENTION

Embodiments of the present invention relate to a speech recognition method and system. The method comprising the steps of providing a speech model, said speech model includes at least a portion of a state of Gaussian, clustering said Gaussian of said speech model to give N clusters of Gaussians, wherein N is an integer and utilizing said Gaussian in recognizing an utterance.

### BRIEF DESCRIPTION OF THE DRAWINGS

FIG. 1a is a flow diagram depicting an exemplary embodiment of a method for recognizing speech in accordance with the present invention;

FIG. 1b is an exemplary embodiment of a block diagram for a system for recognizing speech in accordance with the present invention;

FIG. 1c is an exemplary diagram depicting three (3) categories of Gaussians;

FIG. 1d: a flow diagram depicting an exemplary embodiment of a method for detecting a robust voice activity in accordance with the present invention;

FIG. 1e: an exemplary logic for End-Of Speech (EOS) detection in accordance with the present invention;

FIG. 2: an exemplary audio environment;

FIGS. 3a-3f: exemplary experimental results;

FIG. 4a: exemplary embodiment of a block diagram of a speech recognition system in accordance with the present invention; and

FIG. 4b: exemplary embodiment of a block diagram of a speech recognition network in accordance with the present invention.

### DESCRIPTION OF THE EMBODIMENTS

### 1. Overview

In one embodiment, cluster parameters of acoustic models (HMMs) in ASR provide one or more of: (1) simplified joint compensation for additive and convolutive distortion (JAC) parameter adaptation, (2) simplified Gaussian selection, (3) improved background model, and (4) robust voice activity detection (VAD).

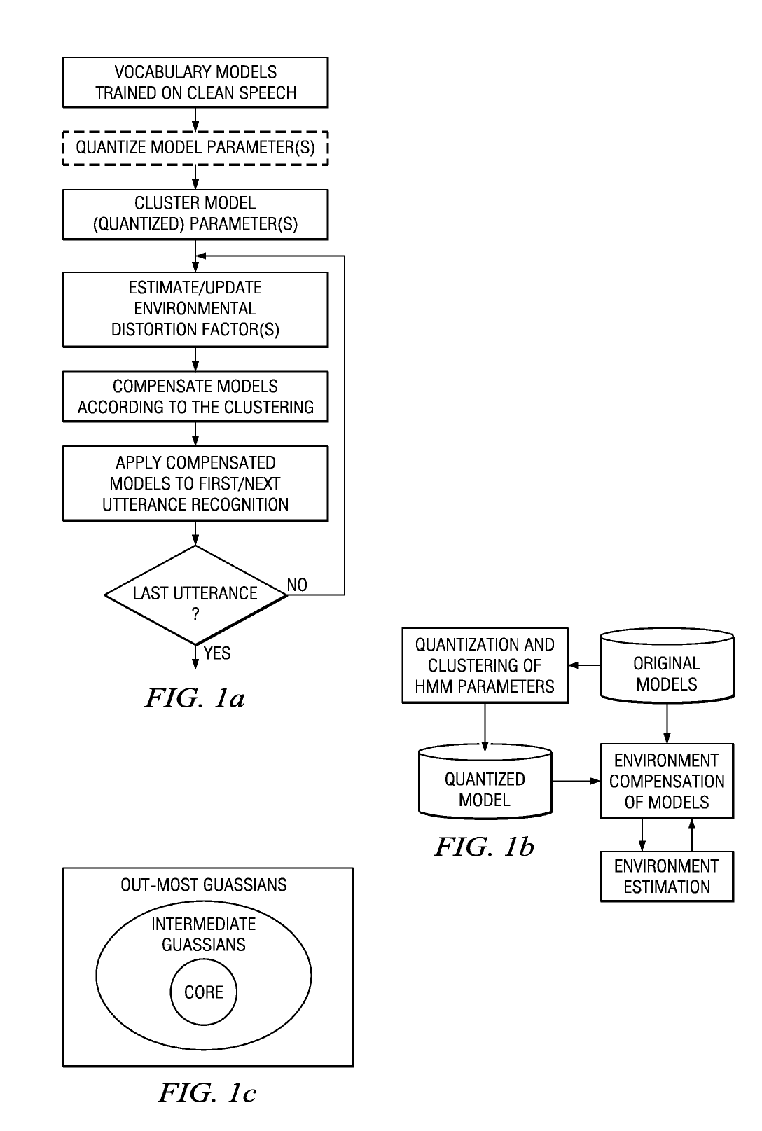

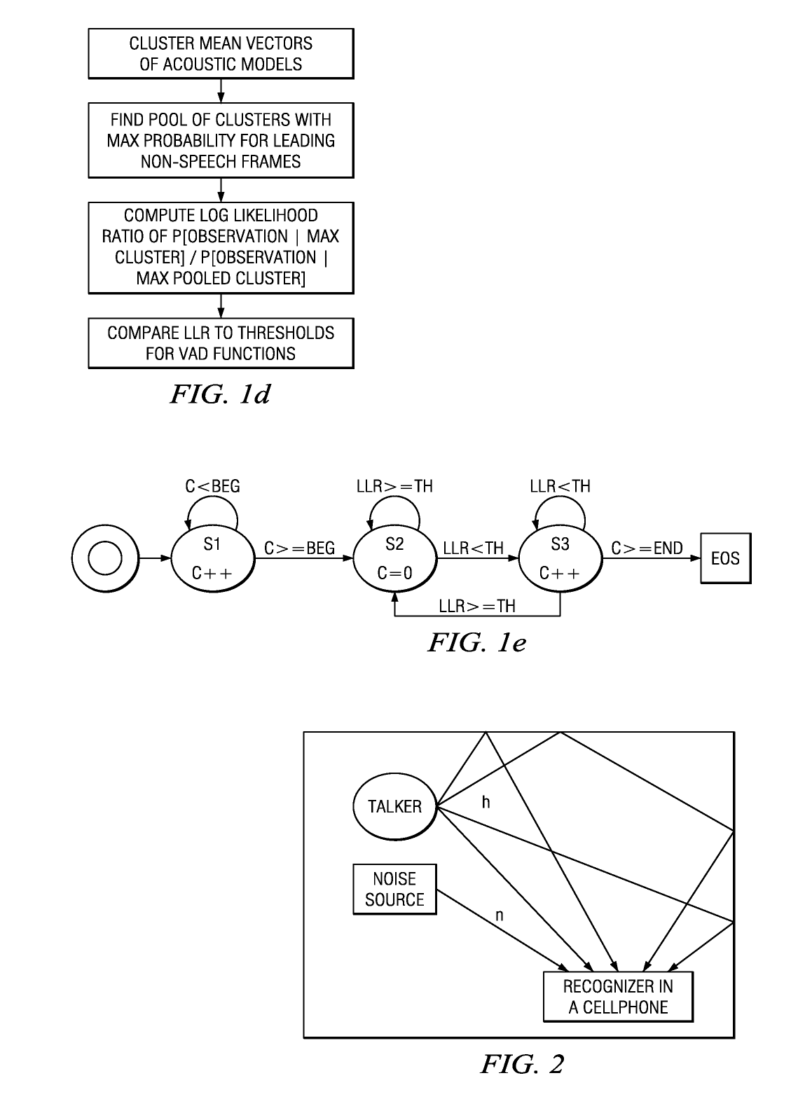

One embodiment, the speech recognition method achieves JAC adaptation on groups or clusters of model parameters. Adaptation of model parameters is tied to each cluster; i.e., within one cluster, model parameters are compensated by the same transformation. The transformation may be simple linear addition of bias vectors. The bias vectors are, however, estimated using a nonlinear function. Since the number of clusters or groups is much smaller than the total number of model parameters to compensate, computational costs are reduced significantly. FIGS. 1a-1b illustrate the cluster-based compensation.

A cluster-dependent method is also used for Gaussian selection, which reduces significantly computational costs for likelihood evaluation. Assign Gaussian mean vectors to three categories; each category has a different resolution and, thus, uses a different approach to compute log-likelihood scores. The core category provides details and, hence, uses triphone log-likelihood scores. Scores of intermediate Gaussian mean vectors are tied to their clusters, and scores of the out-most Gaussian mean vectors are tied globally. FIG. 1c heuristically shows three categories of Gaussians.

An on-line reference model for non-stationary noise consists of a selected list of Gaussian clusters. These Gaussian clusters have wide variance and are selected from a vector quantized codebook of the acoustic models. The selection is based on either a maximum likelihood, which matches clusters to some piloting background statistics, or a maximum a posteriori principle that selects the clusters using background statistics of both the current and the preceding utterances. The log-likelihood of the on-line reference model is used as an adjunct to the log-likelihood of a background model. This results in improved robustness to non-stationary background noise.

A characteristic of the on-line reference model is that the log-likelihood ratio of the best matched cluster relative to the log-likelihood score of the on-line reference model provides a reliable indicator of speech/non-speech events; that is, a robust voice activity detection method is developed using the log-likelihood ratio; see FIG. 1d.

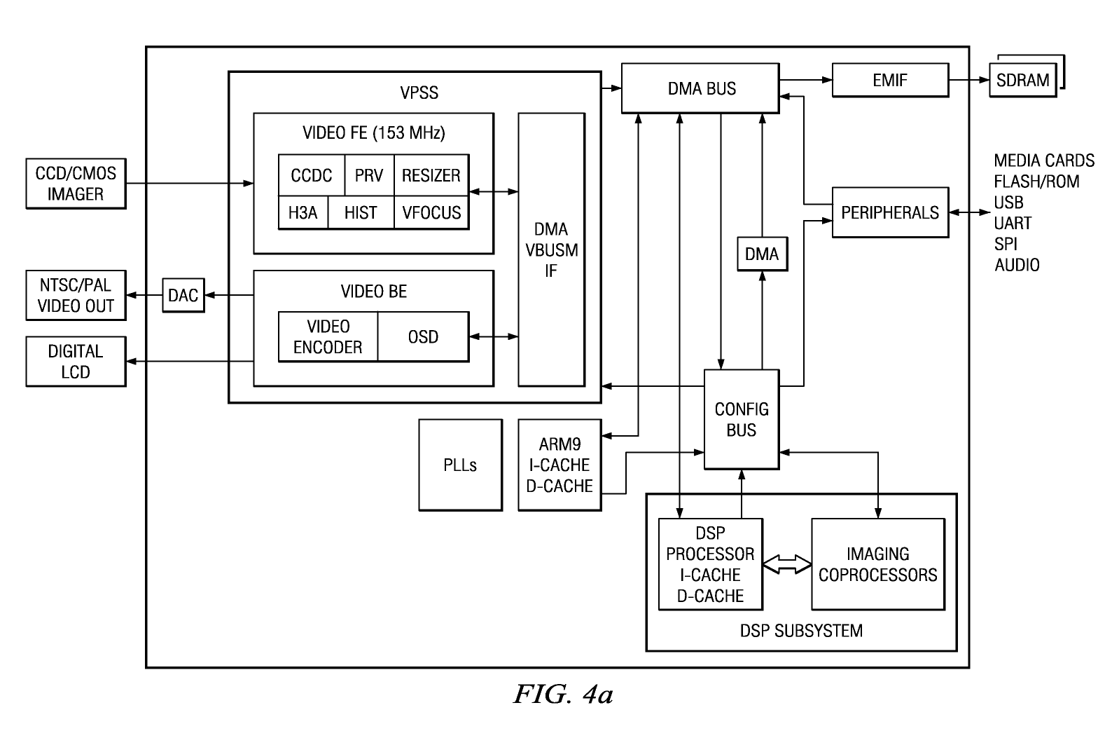

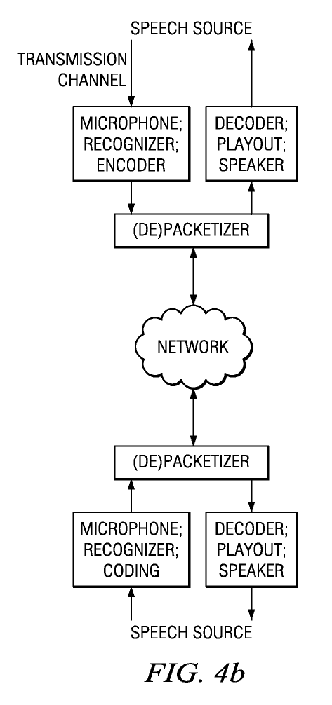

One embodiment of a speech recognition network (cellphones with handsfree dialing, PDAs, etc.) performs with any of several types of hardware: digital signal processors (DSPs), general purpose programmable processors, application specific circuits, or systems on a chip (SoC) which may have multiple processors, such as, combinations of DSPs, RISC processors, plus various specialized programmable accelerators; see FIG. 4a. A stored program in an onboard or external (flash EEP) ROM or FRAM could implement the signal processing. Microphones, audio speakers, analog-to-digital converters, and digital-to-analog converters can provide coupling to the real world, modulators and demodulators (plus antennas for air interfaces) can provide coupling for transmission waveforms, and packetizers can provide formats for transmission over networks, such as, a cellphone network or the Internet; see FIG. 4b.

2. Joint compensation background

This section considers typical methods of joint compensation for additive and convolutive distortion (JAC); and following section 3 describes one embodiment for clustering modification of JAC methods.

JAC methods apply to continuous-density (mixed Gaussians) hidden Markov models (trained on MFCC feature vectors) for speech recognition and presume sampled clean speech, x[m], can only be observed in an acoustic environment which will distort the clean speech with both additive noise and transmission channel modification. This can be modeled as:

y[m]=(h x)[m]+n[m].

where y[m] is the observed speech, h[m] is the transmission channel impulse response, denotes convolution, and n[m] is additive noise. The x[m], n[m], and y[m] would be random processes with n[m] and x[m] independent, and h[m] would be a slowly-varying deterministic transmission channel impulse response which is treated as time-invariant in short time intervals.

A continuous-density model for a particular word (or other speech unit) is trained on clean speech from many speakers of the word to find the model's state transition probabilities plus the mean vectors, variance matrices, and mixture coefficients of the mixed Gaussian densities which define the state observation probability density functions. JAC methods then jointly compensate for the additive noise and the convolutive transmission channel distortions of a particular acoustic environment by modifying the mean vectors (and possibly the covariance matrices) of the clean speech model Gaussians to give compensated model Gaussians for recognition use. The modification of the clean speech mean vectors to find the compensated mean vectors is based on the overall relation y[m]=(h x)[m]+n[m].

Additive noise can be estimated from silence (non-speech) frames during an utterance observation. And the convolutive factor can be estimated from the results of the immediately-preceding one or more recognized utterances (e.g., a running average of convolutive factors): after recognition of an utterance, the corresponding compensated model is re-estimated which provides an updating of the (running average for the) convolutive factor. Use a maximum likelihood method, such as, Expectation-Maximization (E-M), for the convolutive factor updating. A more detailed description follows.

2.1. Clean speech models

Clean speech samples for model building are partitioned into windowed frames with successive frames having a ⅔ overlap. The samples in the frame at time t are denoted x[m; t] with frame size typically 160 samples at a sampling rate of 8 kHz for a 20 ms duration. A 256-point FFT applied to the time t frame clean speech samples (extended to 256 samples by samples from the time t+1 frame) gives X[; t] in the spectral domain. Hence, the spectral energy density for the time t frame is |X[; t]|². Use 20 Mel frequency filters (e.g., ᵢ( ) for 1 i 20) to compute Mel subband spectral energies in the linear spectral energy domain:

X^{lin}[i;t]=ᵢ( )|X[;t]|² for 1 i 20

Typically, the Mel frequency subbands are taken to correspond to original audio frequency bands in the range of 100 Hz to 4 kHz with equal subband width for low frequencies and logarithmic subband width for high frequencies.

Take logarithms to compress to the log-spectral energy domain:

X^{log}[i;t]=log {X^{lin}[i;t]} for 1 i 20

Decorrelate by applying a 20-point discrete cosine transform (DCT) to give cepstral domain coefficients:

X^{cep}[k;t]=DCT_{k,i}(X^{log}[i;t]) for 0 k 19

where the 20×20 DCT matrix has elements C_{k,j} equal to cos[(j+½)k/20] multiplied by a normalization factor.

Define the MFCC feature vector components as X^{cep}[k; t] for 0 k 9; that is, only the 10 lowest frequencies of the 20-point DCTs are used. Also, the delta (plus acceleration) of each component may be included in the feature vector using the slope of a linear fit (or parameters of quadratic fit). For example, a 20-component feature vector would include both X^{cep}[k; t] and X^{cep}[k; t] (the delta) for 0 k 9 with the delta being the difference between adjacent cepstral features:

X^{cep}[k;t]=X^{cep}[k;t] X^{cep}[k;t 1]

Thus, an utterance of length T frames leads to a sequence of T feature vectors where each feature vector has 10 or 20 components: 10 MFCCs, or plus 10 deltas.

For a given utterance, the likelihood that its sequence of feature vectors correspond to a given sequence of modeled triphones can be computed with a Viterbi type of algorithm using the model's state transition probabilities plus the feature vector probability densities of the states. The traceback of the Viterbi algorithm gives the most probable sequence of states and thus, most probable sequence of phones.

A clean speech model for a triphone has state transition probabilities and a probability density function for each state determined from the utterances of the triphone (as a part in words) by many speakers in a noise-free environment. For the mixed Gaussian presumption, the probability density function for state q is modeled as

b_{q}(v)=ₚf_{q,p}G(v,μ_{q,p}, M_{q,p})=ₚf_{q,p}b_{q,p}(v)

where v is a feature vector (e.g., 10 MFCCs plus 10 deltas) in the cepstral domain, f_{q,p} is the mixture weight for the pth Gaussian in state q (so ₚf_{q,p}=1), and G(z, μ, M) denotes a multivariate (e.g, 20 components) Gaussian distribution with a mean vector μ (e.g, 20 components) and covariance matrix M (e.g., 20×20) in the cepstral domain. Find the state transition probabilities and Gaussian means, covariances, and mixture coefficients by training a model with multiple speakers of the corresponding triphone.

Of course, a Gaussian density is

G(v, μ, M)=exp[½(v μ)^{T}M¹(v μ)]/[(2)²⁰detM]^{1/2}

Diagonal covariance matrices can be used without loss of performance due to the decorrelation by the DCT, and the Gaussian may be denoted using the vector of standard deviations: G(v, μ,) where ₖ² is the kth diagonal element of M. Typically, a mixture of 3 to 12 Gaussians can be used.

### 2.2. Model Compensation

The following heuristic translation of y[ ]=(h x)[ ]+n[ ] to the cepstral domain motivates the JAC methods for model parameter compensation. First, transform the windowed observed speech in the time t frame, y[m;t]=(h x)[m; t]+n[m; t], to the spectral domain:

Y[;t]=X[;t]H[;t]+N[;t]

Next, compute Mel subband spectral energies (variables in the linear spectral energy domain):

$${X}^{lin} [ i ; t ] = {}_{i} ( ) {\vert X [ ; t ] \vert}^{2} i = 1 , 2 , … , 20$$

$${N}^{lin} [ i ; t ] = {}_{i} ( ) {\vert N [ ; t ] \vert}^{2}$$

$$\begin{matrix}{Y}^{lin} [ i ; t ] = {}_{i} ( ) {\vert Y [ ; t ] \vert}^{2} \\ = {}_{i} ( ) \{ {\vert X [ ; t ] \vert}^{2} {\vert H [ ; t ] \vert}^{2} + \\ {\vert N [ ; t ] \vert}^{2} + cross terms \} \\ = {H}^{lin} [ i ; t ] {X}^{lin} [ i ; t ] + {N}^{lin} [ i ; t ] + \\ {}_{i} ( ) cross terms\end{matrix}$$

where the cross terms are Re{X[; t]H[; t]N[; t]*}, and H[; t]|² was approximated as a constant (denoted H^{lin}[i; t]) in each Mel subband. The cross terms can be ignored because X[; t] and N[; t] are uncorrelated. Further, the additive noise is estimated during an observed utterance (by use of silence frames preceding and during the utterance) to compute N^{lin}[i; t]. The convolutive factor H^{lin}[i; t] can be estimated as an update of the (running average) convolutive factor used in the immediately-preceding utterance recognition.

Next, take logarithms (for a non-linear compression) to give variables in the log-spectral energy domain:

$${X}^{log} [ i ; t ] = log \{ {X}^{lin} [ i ; t ] \} i = 1 , 2 , … , 20$$

$${H}^{log} [ i ; t ] = log \{ {H}^{lin} [ i ; t ] \}$$

$${N}^{log} [ i ; t ] = log \{ {N}^{lin} [ i ; t ] \}$$

$$\begin{matrix}{Y}^{log} [ i ; t ] = log \{ {Y}^{lin} [ i ; t ] \} \\ = log \{ {H}^{lin} [ i ; t ] {X}^{lin} [ i ; t ] + {N}^{lin} [ i ; t ] \} \\ = log \{ exp ( {H}^{log} [ i ; t ] + {X}^{log} [ i ; t ] ) + \\ exp ( {N}^{log} [ i ; t ] ) \}\end{matrix}$$

Lastly, the 20-point DCT transforms variables from the log-spectral energy domain into the cepstral domain:

X^{cep}[k;t]=DCT_{k,i}(X^{log}[i;t]) k=0, 1, 2, . . . , 19

H^{cep}[k;t]=DCT_{k,i}(H^{log}[i;t])

N^{cep}[k;t]=DCT_{k,i}(N^{log}[i;t])

Y^{cep}[k;t]=DCT_{k,i}(Y^{log}[i;t])

Now JAC methods presume that the Gaussian means and covariances of the compensated models are related to the means and covariances of the corresponding clean speech models in the same manner that the expectation of Y^{cep}[k; t] is related to the expectation of X^{cep}[k; t]. In contrast, the state transition probabilities and mixture coefficients of the compensated models are taken to be the same as the corresponding state transitions and mixture coefficients of the clean speech models. Further, for lower computational complexity, the covariance matrices are typically presumed diagonal and either not compensated or compensated with some other approach, such as, with sequential variance adaptation.

Thus, take expectations (e.g., ensemble averages) in the log Mel spectral energy domain for an utterance with the presumptions that the covariances are zero (so the expectation and be commuted with the log and exp):

$$\begin{matrix}{}^{log} [ i ; t ] = E [ Y {}^{log} [ i ; t ] ] i = 1 , 2 , … , 20 \\ = E [ log \{ exp ( {H}^{log} [ i ; t ] + {X}^{log} [ i ; t ] ) + \\ exp ( {N}^{log} [ i ; t ] ) \} ] \\ = log \{ exp ( {H}^{log} [ i ; t ] + {}^{log} [ i ; t ] ) + \\ exp ( {N}^{log} [ i ; t ] ) \}\end{matrix}$$

where ^{log}[i; t] is the expectation of X^{log}[i; t] and ^{log}[i; t] is the expectation for the corresponding Y^{log}[i; t]. Recall that H^{log}[i; t] and N^{log}[i; t] can be separately estimated and will be used for all of the model compensations. Indeed, n[m; t] may vary rapidly with respect to t, so N^{log}[i; t] is directly estimated, such as, by using silence intervals at the beginning of and within an observed utterance. And h[m; t] varies slowly in time and so H^{log}[i; t] can be estimated by updating from the H^{log}[i; t] of the previous recognized utterance. Typically, the noise power N^{log}[i; t] will be estimated prior to an utterance and presumed constant during the utterance; and H^{log}[i; t] will be smoothed over time by using a running average of estimates from utterance to utterance.

Applying the 20-point DCT to ^{log}[i; t] and ^{log}[i; t] gives the cepstral domain clean speech model mean component [k; t] and the compensated model mean component [k;t] as the kth frequency where only k=0, 1, . . . , 9 are used for the feature vectors. Thus:

$$\begin{matrix}[ k ; t ] = {DCT}_{k , i} ( { }^{log} [ i ; t ] ) \\ = {DCT}_{k , i} ( log \{ exp ( {H}^{log} [ i ; t ] + \\ {}^{log} [ i ; t ] ) + exp ( {N}^{log} [ i ; t ] ) \} ) \\ = {DCT}_{k , i} ( log \{ exp ( {H}^{log} [ i ; t ] + \\ {IDCT}_{i , j} ( [ j ; t ) ) + exp ( {N}^{log} [ i ; t ] ) \} )\end{matrix}$$

where IDCT is the inverse 20-point DCT; DCT_{k,i} indicates that the transform is from i-indexed variable to k-indexed variable. For application of IDCT to a 10-component vector, pad the vector with 0s to make a 20-component vector.

Then presuming that compensation of each of the clean speech model mixed Gaussian means is the same as the change in the overall expectation (mean), the compensation is:

$$\begin{matrix}{}_{q , p} [ k ; t ] = {DCT}_{k , i} ( log \{ exp ( {H}^{log} [ i ; t ] + \\ {IDCT}_{i , j} ( {}_{q , p} [ i ; t ] ) ) + exp ( {N}^{log} [ i ; t ] ) \} ) \\ = {}_{q , p} [ k ; t ] + {g}_{k} ( ( {}_{q , p} [ i ; t ] , {H}^{log} [ i ; t ] , {N}^{log} [ i ; t ] )\end{matrix}$$

where the right side of the equation defines the function gₖ(., ., .) which has one 10-component vector argument (cepstral domain mixture mean vector) and two 20-component vector arguments (log spectral energy domain distortion factors). Vector notation simplifies this to:

_{q,p}=_{q,p}+g(_{q,p},h, n)

with _{q,p} denoting the vector with 10 components _{q,p}[k;t], h denoting the vector with 20 components H^{log}[i; t], n denoting the vector with 20 components N^{log}[i; t], and 10-component vector-valued g(, ,) defined as:

$$\begin{matrix}g ( u , h , n ) = DCT ( h + log \{ 1 + exp ( n h IDCT ( u ) ) \} ) \\ = DCT ( log \{ exp ( h ) + exp ( n IDCT ( u ) ) \} )\end{matrix}$$

Thus, with estimates for H^{log}[i; t] and N^{log}[i; t], JAC methods can compensate the clean speech model mean vectors to give compensated models. Analogous compensation for the variances could also be used, but the performance improvement is not significant in view of the additional computational complexity; rather, a separate variance adaptation method could be used. Also, estimating H^{log}[i; t] and N^{log}[i; t] only at the beginning of an utterance implies the t dependence can be ignored.

Note that for feature vectors with 20 components (e.g., 10 MFCCs and 10 deltas) the compensation for the 10 MFCC components of ^{q,p} follows the foregoing. However, the compensation of the 10 delta components of ^{q,p} differs because the estimates H^{log}[i; t] and N^{log}[i; t] are constant for the frames used to compute Y^{cep}[k; t]; this implies N^{log}[i; t]=0 and only the convolutive compensation applies.

### 2.3. Additive Noise Estimation

As previously noted, n[m; t] may vary rapidly with respect to t, so N^{log}[i; t]] is directly estimated as frequently as possible, such as, by using silence intervals at the beginning of an utterance plus any silence intervals within the utterance. However, silence intervals within an utterance are unlikely for a vocabulary of words or other short audio units, and thus, the noise estimation typically is performed just prior to the utterance and presumed constant during the utterance. Alternatively, the additive noise may be estimated analogously to the convolutive factor estimation as described in the following, although this is computationally costly.

### 2.4 Convolutive Factor Estimation

Update the estimate of the H^{log}[k; t] variables after recognizing each utterance, and employ this updated estimate for the model compensations used for recognition of the next utterance. Typically, use a running average of H^{log} estimates over a few frames to minimize estimation fluctuations.

The estimate update typically applies a method, such as, Expectation-Maximization of alternating E steps and M steps for a convergence to a maximum likelihood estimate of the h parameter. In particular, presume the utterance consisting of the observation sequence Y(1), Y(2), . . . Y(T) of feature vectors was recognized as corresponding to the model=(a_{q*,q}, μ_{q,p}, _{q,p}, f_{q,p}) when the model mean vectors were compensated with n as the estimated additive noise in log-domain together with h as the estimated convolutive factor in the log-domain.

E step: for each t in the observed utterance (t=1, 2, . . . , T) compute the conditional probabilities of the model for observing Y(t) given the state at time t is equal to q (sₜ=q), and the mixture coefficient at time t is equal to p (mₜ=p):

$$\begin{matrix}p ( Y ( t ) \vert {s}_{t} = q , {m}_{t} = p , h , n , ) = {b}_{q , p} ( Y ( t ) ) \\ = G ( Y ( t ) , {μ}_{q , p} , {}_{q , p} )\end{matrix}$$

where _{q,p} depends upon _{q,p,} h, and n through g( , ,) as described above. Note that the diagonal covariance matrix has been presumed diagonal with a vector of standard deviations _{q,p}. That is, the off-diagonal elements of the covariance matrix M are 0, and the kk diagonal element is ²_{q,p,k}.

Then using these conditional probabilities, compute the a probability of sₜ=q and mₜ=p given the observed feature vector sequence, Y(1), Y(2), . . . Y(T) plus the estimated h and n, such as, by the forward-backward method. In particular, define _{q}(t) as the forward probability of state q at time t and _{q}(t) as the corresponding backward probability:

_{q}(t)=p(Y(1) . . . Y(t)|sₜ=q, h, n,)

_{q}(t)=p(Y(t+1) . . . Y(T)|sₜ=q, h, n,)

Then, including the mixture coefficients gives

$$P ( {s}_{t} = q , {m}_{t} = p \vert Y ( 1 ) … Y ( T ) , h , n , ) = [ {}_{q} ( t ) {}_{q} ( t ) / {}_{{q}^{*} {q}^{*}} ( t ) {}_{{q}^{*}} ( t ) ] [ {b}_{q , p} ( Y ( t ) ) / {}_{{p}^{*}}^{}{b}{}_{q , {p}^{*}}^{} ( Y ( t ) ) ]$$

where the sums are for normalization. This a posteriori probability is typically abbreviated as _{q,p}(t) where the h, n, and are implicit.

The forward and backward probabilities are found recursively:

_{q}(t=1)=_{q}*a_{q}*_{,q q*}(t)b_{q}(Y(t+1))

_{q}(t)=_{q}*a_{q,q}* _{q}*(t=1)b_{q*}(Y(t+1))

where a_{j,k} is the model state transition probability from state j to state k. Note that computing the forward probabilities to time T is used to score a model for recognition of an utterance.

M steps: after recognition, update the value of h used during recognition to the value of h̅ which (approximately) maximizes auxiliary function Q( h̅,n, |h,n, ) defined as:

$$\begin{matrix}Q ( ℏ , n , \vert h , n , ) = {}_{tqp} p ( {s}_{t} = q , {m}_{t} = p \vert Y , h , n , ) log \\ \{ p ( Y ( t ) \vert {s}_{t} = q , {m}_{t} = p , ℏ , n , , ) \} \\ = {}_{tqpq , p} ( t ) log \{ p ( Y ( t ) \vert {s}_{t} = q , {m}_{t} = p , ℏ , n , ) \}\end{matrix}$$

where the following abbreviated notation has been used: Y for the observed feature sequence Y(1), Y(2), . . . , Y(T). Intuitively, Q is a sum over t for weighted sums of log likelihood functions for each t with the weights being the probabilities of states and mixture coefficients for current h and n estimates. Thus, the alternating E and M steps will converge to a local maximum likelihood for the h values. Note the implicit presumption that the additive noise is estimated separately, so n appears in both factors in the summed terms; in contrast, the alternative of using an additive noise estimated from the preceding recognition and updating would have differing current n and to-be-updated \check{n} in Q( h̅,\check{n}, |h,n,).

At the maximum Q the derivatives with respect to each component of h̅ are zero, so the goal is to find h* such that:

dQ(h, n, |h,n,)/d h̅ᵢ| _{h̅=h}*=0 for i=1, 2, . . . , 20
and then update h to h*.

Find h* by Newton's method of successive approximations converging to a zero of a differentiable function with each approximation computing an increment from the prior approximation. The first approximation for each component is:

h*ᵢ hᵢ(dQ( h̅,n, |h,n,)/d h̅ᵢ)/(d²Q( h̅,n, |h,n,)/d h̅ᵢ²)| _{h̅=h} i=1, 2, . . . , 20

(Alternatively, the 20-dimensional Newton method could be used:

h* h(Q( h̅,n, |h,n,) [HQ( h̅,n, |h,n,)]¹| _{h̅=h}

where [HQ] denotes the Hessian matrix of Q. The conjugate gradient method could be used to simplify the inverse matrix computation.) Now

dQ( h̅,n, |h,n,)/d h̅ᵢ| _{h̅=h}=_{t q p q,p}(t) dlog{p(Y(t)|sₜ=q, mₜ=p, h̅,n,)}/d h̅|ᵢ| _{h̅=h}

and

d²Q( h̅,n, |h,n,)/d h̅ᵢ²| _{h̅=h}=_{t q p q,p}(t)d²log{p(Y(t)sₜ=q,mₜ=p, h̅,n,)}/d h̅ᵢ²| _{h̅=h}

So the derivatives of the log terms are needed. The log terms are:

$$\begin{matrix}log \{ p ( Y ( t ) \vert q , p , ℏ , n , ) \} = log \{ G ( Y ( t ) , {μ}_{q , p} , {M}_{q , p} ) \} \\ = 1 / 2 [ {( Y ( t ) {μ}_{q , p} )}^{T} {M}_{q , p}^{1} ( Y ( t ) {μ}_{q , p} ) + \\ log \{ {( 2 )}^{20} det {M}_{q , p} \} ]\end{matrix}$$

where μ_{q,p} depends upon h̅ and n through the function g(μ_{q,p,} h̅, n) and the covariance matrix M_{q,p} is presumed diagonal with elements which are the corresponding variances: ²_{q,p;k}.

Differentiating with respect to the variable h̅ᵢ and with the subscript k for the kth component in the cepstral domain plus with the t dependence of μ_{q,p} suppressed:

$$\begin{matrix}d log \{ p ( Y ( t ) \vert q , p , ℏ , n , ) \} / d {ℏ}_{i} = 1 / {2}_{k} [ {( Y ( t ) {μ}_{q , p} )}^{T} {M}_{q , p}^{1} ( Y ( t ) {μ}_{q , p} ) ] / \\ {μ}_{q , p ; k} d {μ}_{q , p ; k} / d {ℏ}_{i} \\ = {}_{k}^{}{( Y ( t ) {μ}_{q , p} )}{}_{k}^{} {/}_{q , p ; k}^{2} d {g}_{k} \\ ( {μ}_{q , p} , ℏ , n ) / d {ℏ}_{i} . \\ = {}_{k}^{}{( Y ( t ) {μ}_{q , p} g ( {μ}_{q , p} , ℏ , n ) )}{}_{k}^{} {/}_{q , p ; k}^{2} d {g}_{k} \\ ( {μ}_{q , p} , ℏ , n ) / d {ℏ}_{i} .\end{matrix}$$

where the diagonal covariance matrix reduced the matrix multiplications to a sum of scalars.

Similarly, the second derivatives are:

$${d}^{2} log \{ p ( Y ( t ) \vert q , p , ℏ , n , ] \} / d {ℏ}_{i}^{2} = {}_{ } {}_{k} 1 {/}_{q , p ; k}^{2} {( d {g}_{k} ( {μ}_{q , p} , ℏ , n ) / d {ℏ}_{i} )}^{2} + {}_{k}^{}{( Y ( t ) {μ}_{q , p} g ( {μ}_{q , p} , ℏ , n ) )}{}_{k}^{} {/}_{q , p ; k}^{2} {d}^{2} {g}_{k} ( {μ}_{q , p} , ℏ , n ) / d {ℏ}_{i}^{2} .$$

The derivatives of g( , , ) follow from the definition:

$$\begin{matrix}d {g}_{k} ( {μ}_{q , p} , ℏ , n ) / d {ℏ}_{i} = {dDCT}_{k} ( log \{ exp ( ℏ ) + exp ( n IDCT ( {μ}_{q , p} ) ) \} ) / d {ℏ}_{i} \\ = d [ {}_{j}^{}{c}{}_{k , j}^{} log \{ exp ( {ℏ}_{j} ) + exp ( {n}_{j} {IDCT}_{j} ( {μ}_{q , p} ) ) \} ] / d {ℏ}_{i} \\ = {c}_{k , i} exp ( {ℏ}_{i} ) / \{ exp ( {ℏ}_{i} ) + exp ( {n}_{i} {IDCT}_{i} ( {μ}_{q , p} ) ) \}\end{matrix}$$

where c_{k,j} are the 20×20 DCT matrix elements.

Likewise, the second derivatives are:

$$\begin{matrix}{d}^{2} {g}_{k} ( {μ}_{q , p} , ℏ , n ) / d {ℏ}_{i}^{2} = {c}_{k , i} exp ( {ℏ}_{i} ) / \{ exp ( {ℏ}_{i} ) + exp ( {n}_{i} {IDCT}_{i} ( {μ}_{q , p} ) ) \} \\ {c}_{k , i} exp ( 2 {ℏ}_{i} ) / {\{ exp ( {ℏ}_{i} ) + exp ( {n}_{i} {IDCT}_{i} ( {μ}_{q , p} ) ) \}}^{2} \\ = d {g}_{k} ( {μ}_{q , p} , ℏ , n ) / d {{ℏ}_{i} ( d {g}_{k} ( {μ}_{q , p} , ℏ , n ) / d {ℏ}_{i} )}^{2} / {c}_{k , i} \\ = d {g}_{k} ( {μ}_{q , p} , ℏ , n ) / d {ℏ}_{i} \{ 1 ( 1 / {c}_{k , i} ) d {g}_{k} ( {μ}_{q , p} , ℏ , n ) / d {ℏ}_{i} \}\end{matrix}$$

Therefore, the first approximation for the h update,

h*ᵢ=hᵢ(dQ( h̅,n|h,n)/d h̅ᵢ)/(d²Q( h̅,n, |h,n)/d h̅ᵢ²)| _{h̅=h}

is computed using the derivatives of Q from the foregoing. The second approximation is a repeat of the foregoing with h replaced by h* from the first approximation. In one embodiment, the speech recognition method uses first or first and second approximations for the updating.

### 3. Clustering of Mean Vectors for Compensation

In one embodiment, the compensation applies a JAC method of mean vector compensation analogous to the JAC methods described in the preceding section but with the mean vectors clustered and with all vectors in a cluster using the same compensation. Explicitly, the mean vector compensation

_{q,p}=_{q,p}+g(_{q,p}, h, n)

is replaced by

_{q,p}=_{q,p}+g(_{c(q,p)}, h, n)

where μ_{c(q,p)} is the cluster center (centroid) of mean vectors for the cluster c(q,p) which contains μ_{q,p}. That is, all mean vectors for all models which are close (in the sense that they are in the same cluster) have the same compensation. This reduces the compensation computations by replacing all of the g(μ_{q,p}, h, n) computations for all of the μ_{q,p} in a cluster with the single compensation computation g(_{c(q,p)}, h, n).

The clustering of the clean speech model mean vectors may follow a quantization of the model parameter values, and any of various clustering methods could be used. The quantization could be as simple as truncating 16-bit data to 8-bit data. Note that the quantization and clustering can be done off-line (after training but prior to any recognition application) and thereby not increase computational complexity. Alternatively, the quantization could be done on-line for each specific task; this would allow for quantization levels adapted to the environment. Also, depending upon the task, a subset, instead of the whole set, of Gaussian mean vectors is used. Hence, off-line and on-line clustering generates different quantized models. The model parameters (state transition probabilities, mean vectors, variance vectors (diagonals of covariance matrices), and mixture coefficients) are separately quantized.

Given the quantized-parameter clean speech models, in one embodiment, the method clusters the mean vectors but not the variance vectors. The mean vectors are first grouped together. A weighted Euclidean distance for the mean vectors is defined as:

d(μ_{q,p}, μ_{q*,p*})=1/D_{k=1 . . . D}w(k) (μ_{q,p;k} μ_{q*,p*;k})²

where D is the dimension of the feature space (e.g., D=10 or 20) and k denotes the kth vector component. The weight w(k) is equal to the kth diagonal element of an inverse covariance matrix estimated as the inverse of the average of the covariance matrices of the Gaussian densities in the models. That is,

w(k)=1/²_{ave,k}

where the average covariance matrix (or average variance diagonal vector) is

²ₐᵥₑ=(1/N_{G})_{p,q}²_{p,q}

with N_{G} denoting the total number of Gaussians. So the feature vector components with larger variances on average over all densities have smaller weights in the distance measure for clustering, so more “accurate” feature components dominate the clustering.

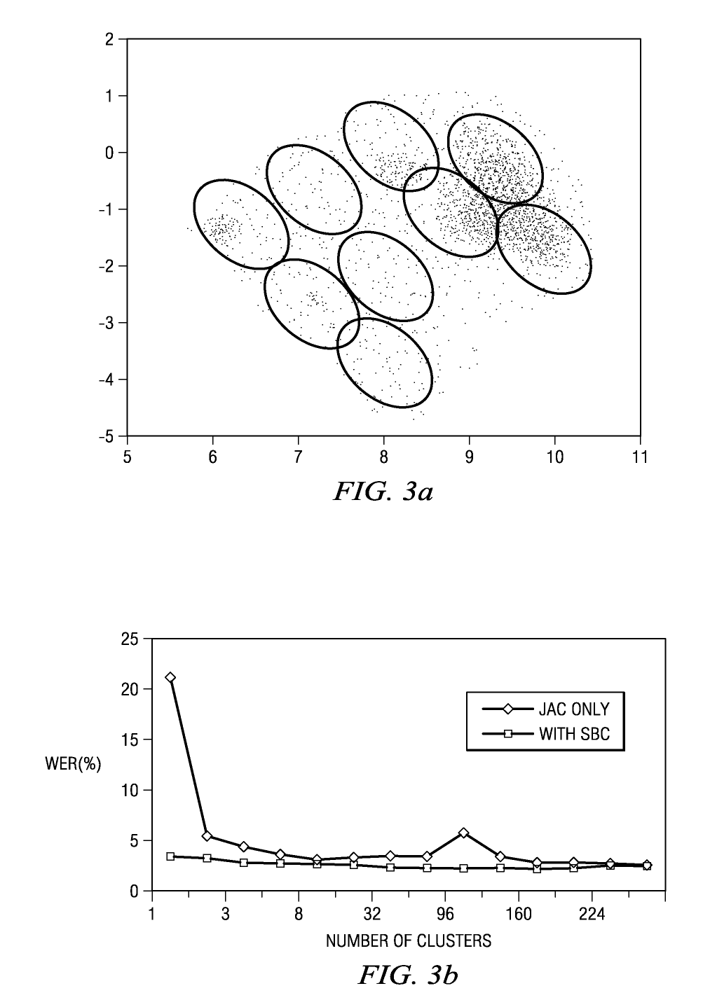

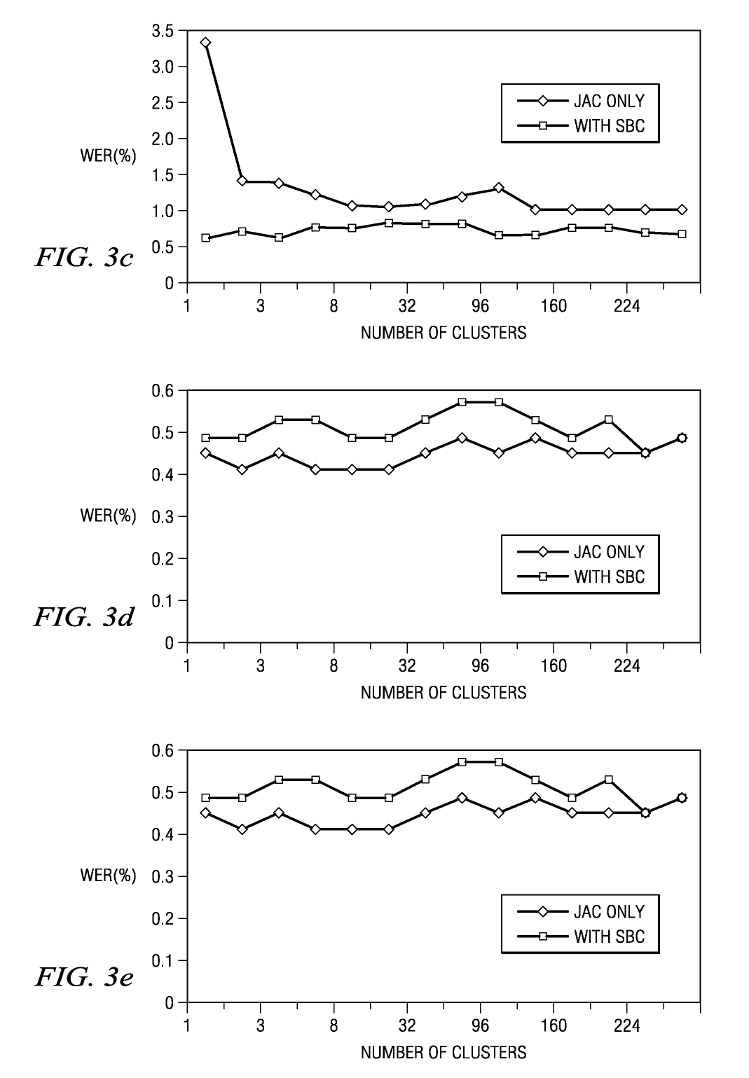

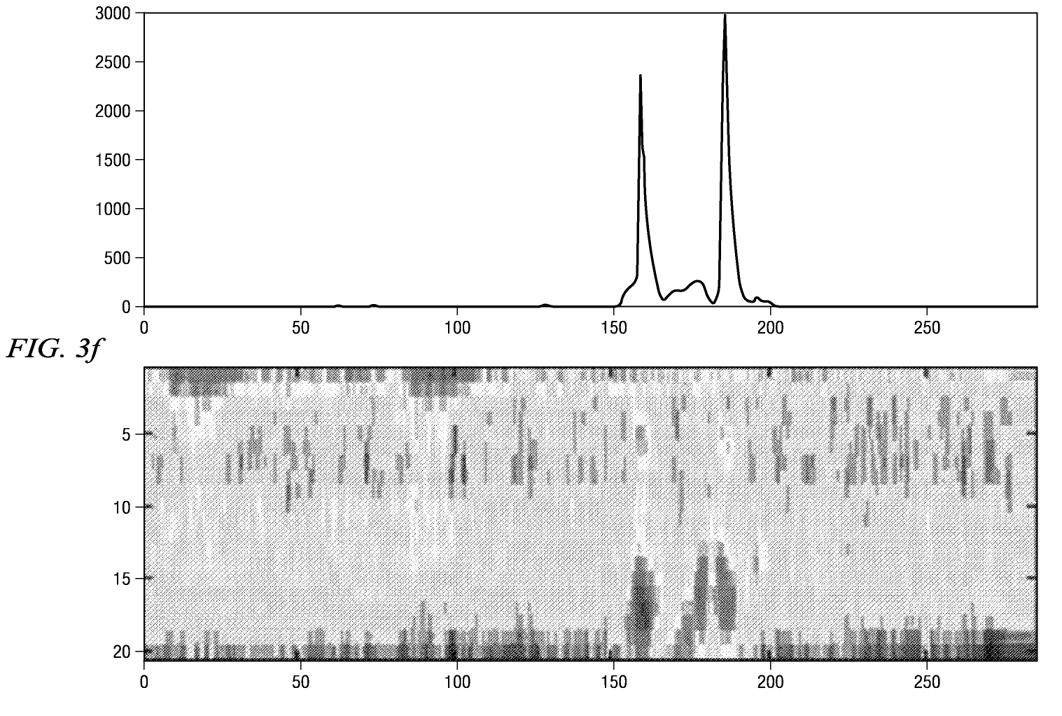

Given the distance measure, in one embodiment, the compensation performs a K-means clustering method with Z clusters; Z on the order of 128 has usually worked experimentally. Explicitly, clustering may proceed as follows:
1. Randomly assign each of the clean speech model mean vectors, μ_{q,p}, to one of Z sets (there may be on the order of 10,000 mean vectors).
2. Compute the centroid of each of the Z sets; that is, find the average of each component for all mean vectors in the set; the centroid is the vector with these averages as components.
3. Assign the mean vectors to the closest centroid using d(μ_{q,p}, μ_{centroid}) to measure for closeness; this forms Z new sets.
4. Compute the new centroids of these new sets.
5. Repeat the third and fourth steps until the Z centroids converge to Z limits. The final sets of mean vectors are the resultant Z clusters, one for each of the Z limit centroids. Of course, the resultant clusters may have differing numbers of elements. FIG. 3a is a scatter diagram illustrating mean vector components 0 and 1 (out of 20) of an example of clustering; notice that because each cluster has the same covariance given by w(k), the orientations of clusters are all the same.

After the clustering, for each cluster save the cluster centroid to memory. In addition, to the cluster centroid, a table mapping of original mean vector indices q,p to the corresponding cluster index, c(q,p), is saved to memory. Thus, this embodiment's compensation, with off-line quantization and clustering, is used in one embodiment the recognition, which may include the following steps:

(a) find clean speech model parameter values by training on clean speech;

(b) optionally, quantize the model parameter values from step (a);

(c) cluster the mean vectors from (b);

(d) initialize environmental parameter (additive noise and convolutive factor) estimates;

(e) compensate model mean vectors using current environmental parameter estimates and with a common compensation for all mean vectors in a cluster;

(f) recognize an utterance using the compensated models from (e), optionally, the additive noise is estimated during initial silence frames of the utterance being recognized and used for compensation along with the current convolutive factor estimate; of course, the recognition computes the probability of the observed sequence of feature vectors for each compensated model and then recognizes the utterance as the sequence of triphones (or other speech unit) corresponding to the sequence of models with the maximum likelihood;

(g) update environment parameters (convolutive factor and, if not estimated during recognition, additive noise) as described above;

(h) recognize the next utterance by going back to step (e) and continuing.

FIG. 1a is a flow diagram depicting an exemplary embodiment of a method for recognizing speech in accordance with the present invention; and FIG. 1b is an exemplary embodiment of a block diagram for a system for recognizing speech in accordance with the present invention.

Note that to reduce computational costs for model-based environment compensation, others have proposed a Jacobian adaptation method, which basically reduces costs by linearizing the nonlinear formulae in PMC and JAC-like this embodiment's compensation. In one embodiment, the compensation differs from Jacobian adaptation in that Jacobian adaptation linearizes to reduce computational costs, and the linearized function is applied to every state and mixture. In contrast, the compensation applies a tied compensation vector estimated from the nonlinear function. Although the function is still non-linear, the computational costs are reduced because only a few cluster-dependent compensation vectors are computed. Once the compensation vectors are estimated, each one is applied to every mean vector within the corresponding cluster.

In one embodiment, the method may have lower computational costs than Jacobian adaptation because despite the function being linearized in Jacobian adaptation, it is different for every mean vector and, thus, needs to be computed for every mean vector.

### 4. Clustering for Gaussian Selection

Gaussian selection methods have been proposed to reduce computational costs for the likelihood evaluations used to score models for an input utterance. Indeed, for triphone models the number of models is several thousand even for a small number (e.g., 43) of underlying monophones, and thus, hundreds of thousands of Gaussians could be involved. The concept of Gaussian selection is as follows. The likelihood of a feature vector can be approximated accurately only when it does not land on the tail of a Gaussian density. Also, when the feature vector does land on the tail of a Gaussian density, the likelihood will be small, and thus, it would not contribute much to the state score, which is the sum of scores from individual Gaussian components of the state in an HMM. Usually, the likelihoods of the rest of the Gaussians would be set to some small value. More explicitly, for the observed feature vector sequence Y(1), . . . , Y(T), the likelihood computation uses the forward probability recursion:

_{q}(t)=_{q*}a_{q}*_{,q q}*(t 1) b_{q}(Y(t))

where the state probability is computed as a sum over the mixture of Gaussians for that state:

b_{q}(Y(t))=ₚf_{q,p}G(Y(t),μ_{q,p, q,p})

Now for Y(t) not near μ_{q,p} (in units of _{q,p}), the term G(Y(t), μ_{q,p, q,p}) can be approximated by some small value.

Usually, the small values are presumed to carry little information for recognition; however, observations have suggested that they do contribute to recognition performance. For example, instead of using a global small value, Lee et al. (ICASSP 2001) use context-independent monophone models to provide back-up scores for context-dependent triphone models where the center phone of the triphone corresponds to the monophone, and this provides more accurate scores than the global small value approaches.

In contrast, in this embodiment, the Gaussian selection methods first compute distances of the input feature vector to the centroids of mean vector clusters where the clusters and centroids are those previously determined and described in section 3 with regard to the compensation. The distance measure is a squared weighted Euclidean distance:

d(Y(t), μ_{c(q,p)})=(1/D)_{k=1 . . . D}w(k) (Y(t)ₖ μ_{c(q,p)k})²

where Y(t)ₖ is the k-th component of the input feature vector Y(t), μ_{c(q,p)k} is the kth component of the centroid μ_{c(q,p)} of cluster c(q,p), and as in section 3, the weight w(k) is equal to the kth diagonal element of an inverse covariance matrix estimated as the inverse of the average of the covariance matrices of all of the Gaussian densities in the models.

Given the distances, the selection may categorize the centroids (and their cluster Gaussian mean vectors) to one of three categories: core, intermediate, and out-most. That is, mean vector μ_{q,p} is in the core category when d(Y(t), μ_{c(q,p)}) is less than Threshold1, is in the intermediate category when d(Y(t), μ_{c(q,p)}) is between Threshold1 and Threshold2, and is in the out-most category when d(Y(t), μ_{c(q,p)}) is greater than Threshold2; where Threshold1 and Threshold2 are adjusted to control the number of mean vectors or clusters in each category. For example, with a total of 128 clusters, the experimental results of section 7 came from a categorization with 50 core clusters, 30 intermediate clusters, and 48 out-most clusters.

Each category has a different resolution and, thus, uses a different approach to compute log-likelihood scores. Mean vectors in the core category provide details and, hence, use triphone log-likelihood scores. Scores of mean vectors in the intermediate category are tied to their clusters, and scores of the mean vectors in the out-most category are tied globally. FIG. 1c is a heuristic diagram of the cluster categorization.

More explicitly, when μ_{q,p} is in the core category, then G(Y(t), μ_{q,p, q,p}) is evaluated. When μ_{q,p} is in the intermediate category, then G(Y(t), μ_{q,p, q,p}) is approximated as G(Y(t), μ_{c(q,p), c(q,p)}) where μ_{c(q,p)} is a compensated mean vector for the cluster and _{c(q,p)}² is a corresponding cluster variance. The compensated mean vector is

_{c(q,p)}=_{c(q,p)}+g(_{c(q,p)}, h, n)

Likewise, the cluster covariance matrix is diagonal with variance vector _{c(q,p)}² having kth component _{c(q,p),kk}²=1/w(k) which is just the kth diagonal element of the overall average diagonal covariance matrix. And when μ_{q,p} is in the out-most category, then G(Y(t), μ_{q,p, q,p}) is approximated as G(Y(t), μ_{global, global}) where μ_{global} is a global compensated mean vector for all of the out-most clusters and _{global}² is a corresponding variance vector. In practice, the global compensated mean and its corresponding variance are not computed. Instead, an empirically chosen real number is assigned as the score from G(Y(t), μ_{global, global}).

The Gaussian selection may have the following benefits.
(1) Instead of using either context-independent models (e.g., monophone model corresponding to center phone of triphone) or a global small value for the log-likelihood score, the small values in the Gaussian selection may either be tied to their clusters or tied globally.
(2) The clusters of the mean vectors in the Gaussian selection may be obtained via a data-driven way (the distance measure) and, hence, may provide the best approximation of the distribution of the context-dependent models. Another benefit is that the number of clusters in the data-driven clustering scheme can be controlled; whereas, the number of context-independent models are fixed (e.g., the number of phones in the vocabulary) and cannot be controlled.
(3) Notice that, although the scores of those clusters which are far away from the feature vector are small, they are still distinct and, thus, may provide distorted information. Hence, this selection may use a global score for those clusters, which are called out-most clusters, penalizes them, and disregards their influences on likelihood evaluation.

### 5. On-Line Reference Modeling

The on-line reference modeling (ORM) may dynamically construct a reference model for non-stationary noise using a selected list of Gaussian clusters from a codebook of the quantized acoustic models. The reference model improves robustness to non-stationary noise. Moreover, the reference model can be used to construct a voice activity detector (VAD) based on log-likelihood ratios. The ORM method includes the following.

### 5.1 Gaussian Clustering

First, during vector quantization of the acoustic models, the mean vectors of the Gaussians found from training are (quantized and) clustered. As in sections 3-4, a weighted Euclidean distance is defined for this clustering:

d(μᵢ, μⱼ)=1/D_{k=1 . . . D}w(k)(μ_{i;k} μ_{j;k})²

where D is the dimension of the feature space (e.g., D=10 or 20) and k denotes kth vector component. The weight w(k) is equal to the (k,k) element of an inverse diagonal covariance matrix estimated as the inverse of the average of the diagonal covariance matrices of all of the Gaussian densities in the acoustic models:

w(k)=1/²_{ave,k}

where the average diagonal covariance matrix (average variance vector) is

²ₐᵥₑ=(1/N_{G})_{n=1 . . . N}₂ₙ

where N_{G} denotes the total number of Gaussians in the acoustic models.

As described in section 3, given this distance function, a K-means algorithm is performed to cluster the mean vectors with c(i) denoting the cluster containing mean vector μᵢ. After clustering, for each cluster, c(i), its cluster centroid vector, μ_{c(i)}, is saved, and μᵢ is quantized as μ_{c(i)}, which may include both ORM and section 3 and/or 4 may use the same clustering for ORM and the section 3/4 applications.

Each cluster provides a probability density function (PDF) of MFCC feature vectors. As the union of all of the clusters is approximate the PDF of the MFCC feature vectors, the summation of the variances of the clusters is approximate the variance of all of the Gaussians. Hence, take the cluster variance to be:

²_{cluster}=(1/Z)_{1 n N}_{_{G}} ²₂

where ²ₙ is the variance of the n-th Gaussian, ²_{cluster} is the variance of each cluster, N_{G} denotes the number of Gaussians, and Z denotes the number of clusters, which equals 128 for the experimental results of section 7.

Notice that each cluster may have statistics (Gaussian mean vectors) that are used by different phones; see the example in subsection 5.3.

### 5.2 Environmental Compensation of Clusters

The clusters are obtained from acoustic models trained on clean speech data. To approximate the statistics in real environments, the clusters are adapted (centroid mean vector adapted) to decrease the mismatch between statistics from the clean speech conditions and statistics as described by the mean vector compensation in section 3:

μ_{c}=μ_{c}=g(μ_{c}, h, n)

with a compensated centroid, μ_{c}, the likelihood of observation of Y(t) given cluster c is

p(Y(t)|c)=G(Y(t); μ_{c, cluster}²)

Notice that all of the clusters have the same variance _{cluster}²; hence, the likelihood measures the closeness of a feature vector Y(t) to the centroid. From the implementation point of view, using the same diagonal covariance matrix for all clusters (i.e., same variance vector) simplifies the likelihood calculation, as the determinant of the covariance matrix (product of the variance vector components) is common to all clusters and can be shared once it has been computed.

### 5.3 On-Line Reference Model Construction

A reference model is defined as a set of models that cover a wide range of background statistics specific to an utterance. The background statistics differ from the statistics of speech events in the following ways:

(1) The background statistics are wide. In this sense, a reference model needs to have large variance. To achieve wide variance, the on-line reference model (ORM) uses a list of clusters, and each cluster has large variance.

(2) However, too wide a variance may decrease discriminative power of a decoder. Hence, a reference model needs statistics from some known background segments. So the lists of clusters are selected using statistics of the non-speech segments of the current utterance.

The leading frames, before a speech event, may be used to construct the ORM. In particular, at frame t in the non-speech segment, a cluster is selected as the cluster that is the closest match to the input feature vector Y(t); i.e., the reference cluster at t is:

r*(t)=arg max_{c Z} p(Y(t)|c)

Notice that, instead of using the leading frames for constructing JAC elements and compensating the acoustic models, the ORM uses the leading frames for model construction. The leading frames for ORM may not be the same as those for JAC.

These reference clusters are pooled together as M={r*(1), . . . , r*( )} where is the number of leading non-speech frames. It is possible that there are duplicated cluster indices in M. so let C denote the unique clusters in M. Thus, the ORM could be written as:

p(. . . |ORM)=_{c C} w_{c}G(. . . ;μ_{c, cluster}²)

where the weights, w_{c}, reflect the number of times a cluster appears in M. However, during recognition the score of the ORM may be computed as

p(Y(t)|ORM)=max_{c C} p(Y(t)|c)

The following list illustrates an example of an ORM constructed from eight leading frames, together with a list of the center phones which have a mean vector within the corresponding cluster. This ORM was constructed from an utterance distorted in 10 dB TIMIT speech and using 128 clusters.
cls[49 ]→phones: 39 34 23 24 20 11 14 2 18
cls[24 ]→phones: 27 22 26 39 19 41 37 11
cls[50 ]→phones: 44 34 14 12 8 41 2 18
cls[52 ]→phones: 37 34 20 38 39 26 25 10
cls[57 ]→phones: 44 27 40 11 14 35 47 25 12
cls[87 ]→phones: 12 40 35 9 21 24 27
cls[117 ]→phones: 43 33 21 6 18 24
cls[42 ]→phones: 23 39 46 2 24

This example shows that each cluster, such as, cluster cls[42], has statistics that are used by some triphones with center phone indices 23, 39, 46, 2, or 24. It also shows that the ORM has many clusters, so that a wide range of statistics is supported by the ORM.

### 5.4 ORM Reference Model in ASR

The ORM method dynamically constructs a list of models (e.g., clusters from the leading non-speech frames); and these models have sufficient variance to cover a wide range of statistics. As noted in subsection 5.3, the models are selected using the statistics of known non-speech segments.

The ORM is used together with a Silence model, also known as Background model, during the recognition process. In practice, ASR system may not have an explicit label for the ORM, but substitutes the score from a Silence model as

p( . . . |Silence)=max{p( . . . |Silence),p( . . . |ORM)}

Instead of using a database of all of garbage signals, such as, cough, the ORM uses the acoustic models that are trained not only from background signals but also from speech signals. Hence, the ORM is derived from the acoustic models. This differs significantly from some other methods, such as, garbage modeling.

### 5.5 Updating ORM

The ORM reference obtained in the above process consists of a list of clusters. Notice that the list of clusters has meaning similar to fenones, which are data-driven representations of speech and background features. The ORM cluster list is obtained from the current utterance using the maximum likelihood principle. Further improvement may be achieved by updating the list using statistics from previous utterances. In such a way, a smoothed list of clusters may be obtained.

In particular, define Count(c) as the count of cluster c in the ORM from the current utterance; that is, the number of times c appears in the original set M of clusters used to construct the ORM in subsection 5.3. The probability of cluster c in the ORM is therefore

w_{c}=Count(c)/

where, as mentioned before, is the number of non-speech frames used to construct ORM. Notice that

_{c C w}_{c}=1

For all Z cluster, define ŵ_{c} as the probability of cluster c carried over from the previous utterance (note that ŵ_{c} may equal 0 if cluster c did not appear in any of the prior utterances or had been removed). Then, update these probabilities with a simple smoothing of the current utterance clusters:

ŵ_{c}=αw_{c}+(1 α)ŵ_{c}

where the weight α is usually set to 0.5 but may be smaller, such as, 0.05-0.20, for roughly stationary noise.

Normalize the updates to provide probabilities:

w_{c}*=ŵ_{c}/_{k Z}ŵₖ

Then, set a threshold to remove those clusters with low probabilities:

M*={c|w_{c}*}

Of course, the smaller the threshold, the larger the number of clusters that are selected in the ORM. In the extreme case of=0, all of the clusters in the previous utterances and those selected from the current utterance are in the ORM. And conversely, increasing decreases the number of clusters in the ORM.

### 6. ORM Application to VAD

The score from the reference model p(Y(t)|ORM) is used in the recognition process as an adjunct to the silence model. In addition, a measure of the log-likelihood of the best matched cluster of all Z clusters relative to the log-likelihood of the ORM can be used for voice activity detection (VAD). In particular, define a log-likelihood ratio (LLR) as:

LLR(t)=log{p(Y(t)|c*)/p(Y(t)|ORM)}

where c* {1, . . . , z} is the best matched (largest conditional probability) cluster in the quantization code book. Recall that p(Y(t)|c)=G(Y(t); μ_{c, cluster}²)

In example of the LLR is plotted in FIG. 3f. The lower part of the figure is the log-spectral power of a speech utterance contaminated by leading “bump” noise. It is clear that the “bump” noise is in the lower frequency filter banks. The upper part of the figure is LLR(t). It is clear that the LLR in a speech event is much larger than the LLRs in other segments.

Based on this observation, voice activity detection (VAD) may use the LLR measure. Initially, note that VAD performs three functions: (1) voice beginning detection (VBD), (2) frame dropping in the middle of speech (FD) detection, and (3) end-of-speech (EOS) detection. The LLR can be used for these three functions as follows.

### 6.1 Voice Beginning Detection.

Speech frames are buffered (FIFO) until the beginning of voice (speech) which is detected when the LLR is above a threshold. In particular, a noise-level dependent threshold is defined as follows:

$${ }_{VBD} = {}_{high} when {\check{N}}_{N} = {}_{low} when {\check{N}}_{N}$$

where the noise-level \check{N} is the averaged log-spectral power in the beginning 10 frames of an utterance. The noise-level threshold _{N} is empirically determined; for example, it is 23.44 for the experimental results of section 7. The thresholds _{high} and _{low} are selected to accept as many speech events as possible. At the same time, the thresholds are high enough that false triggering of speech events by noise, such as, “bump” noise in FIG. 3f can be rejected. Typical values would be _{high}=1.25 and _{low}=2.34.

The VAD method works well if there is indeed a background signal to learn the statistics for ORM. However, for such sounds, such as, “V” and “S” which have a consonant at the beginning, the energy based VAD may be triggered from vowel part. Backing up a certain number of frames does not necessarily retrieve background signal. Instead, it is highly possible that the retrieved signal belongs to consonant.

One way to solve the problem is based on the observation that the above occurs when noise level is low. Hence, when the noise level is low, ORM is not used in VAD.

### 6.2 Frame Drop

Long pauses between speech events are possible in an utterance. Those signals of long pauses may confuse the recognition engine and the computational resources in a decoder are also wasted. Hence, in one embodiment may use a mechanism of drop frames corresponding to long pauses and silence from the decoding process. The logic of FD is if LLRs are continuously below a certain threshold, _{FD}, the incoming frames are buffered instead of sending them to the decoder. The buffering process is stopped until the LLR is above the threshold _{BVD}, defined in the previous subsection. The threshold _{FD} usually has a low value; for example, it is 0.094 for the experimental results.

### 6.3 End of Speech.

The logic of the EOS detection is shown in FIG. 1e. The states S1 to S3 consist of the following functions.
S1: Decode the incoming frame in ASR engine if the number of frames processed is not more than a threshold BEG. If the number is larger or equal to the threshold, go to state S2. BEG could have a default value of 30 frames.
S2: The LLR is compared to a threshold TH. If the LLR is lower than the threshold, a counter (C in FIG. 1e) is incremented. Otherwise, the counter is set to zero. The threshold TH is updated as a percentage of the maximum LLR. The percentage is by default 10%.
S3: The counter is incremented. If the number is above a number, END, end of speech (EOS) is detected. If, however, the LLR is larger than the threshold TH before the EOS is detected, the counter is reset to zero. The number END could have a default value of 80 frames.

### 7. Experimental Results

Such methods were evaluated using the WAVES database, which was collected in vehicles using an AKG M2 hands-free distant talking microphone in three recording environments: parked car with engine off; stop-and-go driving; and highway driving. Thus, the utterances in the database were noisy. The utterances were sampled at 8 kHz with a 20 ms frame rate, and 10-dimensional MFCC features were derived. There were 1325 utterances of English names by 10 male and 10 female talkers. Each talker spoke up to 90 names.

Baseline triphone models were constructed as generalized tied-mixture models. Performance in the three driving environments are plotted in FIGS. 3b-3d for highway, stop-and-go, and parked, respectively. These results show:
(1) Generally, increasing the number of clusters can reduce word error rates (WER) of the cluster-dependent JAC methods. The worst performance was with one cluster corresponding to a single global shift for all mean vectors. One cluster is insufficient to compensate environmental distortion on clean speech mean vectors. However, with four clusters, WER is reduced below 5%. Further increasing the number of clusters does not provide significant reduction of WERs.
(2) Stochastic bias compensation (SBC) is a method that combines JAC-like methods with MLLR-like methods. The experimental results show that the combination of SBC and the cluster-dependent JAC is very effective in reducing WERs. Even with only one cluster for cluster-dependent JAC, SBC is able to reduce WER below 5%.

Experiments with eight types of Aurora noise were also performed. Averaged WERs by the cluster-dependent JAC over the eight types of noise are shown in FIG. 3e, together with those combined with SBC. The trends obtained are similar to the results without Aurora noise.

The computational costs were measured. With 128 clusters, the compensation may use 90 million cycles for environmental compensation and 153 million cycles for environmental estimations. The JAC method without clustering uses 2133 million cycles for environmental compensation and 153 million cycles for environmental estimations.

Experiments with the Gaussian selection were performed with the same database and 128 clusters categorized as 50 core, 30 intermediate, and 48 out-most. A typical result is shown in the following table of WER and number of Gaussian computations per frame:

| | Parked | Stop-and-go | Highway |
|---|---|---|---|
| w/o Gaussian | 0.83% WER; | 0.90% WER; | 2.24% WER; |
| selection | 894 comps | 1051 comps | 1397 comps |
| w Gaussian | 0.61% WER; | 0.77% WER; | 2.36% WER; |
| selection | 447 comps | 545 comps | 747 comps |

The experiments show that the Gaussian selection does not affect performance on the database, and that the number of Gaussian computations per frame, which also includes those for computing the distance for clustering, is reduced by roughly one half.

The overall clustering relating to the present invention result indicates that for compensated JAC alone (or with SBC) only a small number of clusters suffices; however, to also effectively apply Gaussian selection, the number of clusters cannot be too small.

The on-line reference model (ORM) methods of sections 5-6 have advantages for robust speech recognition on embedded devices, including:

(1) The method significantly enhances noise robustness of speech recognition and VAD;

(2) Since the method uses quantization of acoustic model, and this process is also used in some speed-up methods, such as, Gaussian selection of section 4 and cluster-dependent JAC of section 3, the additional cost is for constructing the ORM and VAD. In fact, compared to other intensive computations, search, the additional cost is very low. The saving of computational cost due to the improved VAD and improved ORM is much more significant; and

(3) The additional requirement on memory footprint is very low. In fact, only a few tens of bytes are required to save ORM and parameters in VAD.

To test the recognition performance of the ORM with VAD, we constructed a new database consisting of name utterances in the original WAVES database but contaminated by 8 types of 10 dB Aurora noise. The leading and trailing background (non-speech) lengths of the utterances were varied randomly, from 0.5 second to 5 seconds, to mimic the sampled data in real usage of our SIND system. The database is in contrast to a database using Aurora noise which has the same utterance lengths as the WAVES database, and which consists of utterances with manually segmented speech and short utterance lengths. Results on the new database, together with the results on the old database, are shown in the following Table; the cluster probabilities updating is denoted as PU, and is with default threshold as of 10%. The baseline (which used energy-based VAD) was evaluated on the new database and obtained 4.84% WER averaged on the 8 types of Aurora noise. Conversely, the baseline had 1.22% WER on the original database.

Moreover, the computational cost of the baseline on the new database was 42185 million CPU cycles, whereas it had 3227 million CPU cycles on the original database. Clearly, because of failure of the energy-based VAD, the system suffered in both the recognition performance and computational speed.

| | | | | | | | ORM + |
|---|---|---|---|---|---|---|---|
| | | | ORM + | ORM + | ORM + | ORM + | PU(10%) + |
| | baseline | ORM | PU(20%) | PU(10%) | PU(5%) | VAD | VAD |
| New DB: WER | 4.84 | 4.27 | 3.55 | 3.61 | 3.97 | 2.29 | 2.01 |
| New DB cost | 42185 | 36744 | 34010 | 32675 | 34831 | 6614 | 6381 |
| Old DB WER | 1.22 | 1.13 | 1.05 | 1.06 | 1.13 | 1.26 | 1.07 |
| Old DB cost | 3227 | 4384 | 3632 | 4020 | 4675 | 3526 | 3529 |

### 8. Modifications

The embodiments may be modified while retaining one or more of the features of clustering for environmental compensation and clustering for Gaussian selection.

For example, the models could be clustered in a different way and the categorization could be reduced to two categories. The deltas could be slopes of linear fits to more than two MFCC vectors; acceleration vector components could be added to the MFCC and delta vector components (e.g., a 30-component vector). The distance measure for clustering could be modified with different weights or absolute differences could replace square differences, (default) thresholds could be adjusted, the cluster probabilities update parameter varied, and so forth.

While the foregoing is directed to embodiments of the present invention, other and further embodiments of the invention may be devised without departing from the basic scope thereof, and the scope thereof is determined by the claims that follow.

What is claimed is:

1. A speech recognition method, comprising the steps of:
providing a speech model, said speech model includes at least a portion of a state of Gaussian;
clustering said Gaussian of said speech model to give N clusters of Gaussians, wherein N is an integer; and
utilizing said Gaussian in recognizing an utterance.

2. The speech recognition method of claim 1, wherein the step of recognizing said utterance comprising:
compensating said Gaussian for distortion resulting in a compensated Gaussian, where said compensating derives from a cluster containing said Gaussian; and
using said compensated Gaussian for compensated models for recognition of an utterance.

3. The speech recognition method of claim 1 further comprising the steps of:
estimating said distortion after recognition of a first utterance; and
using said estimation for the recognition of a second utterance.

4. A speech recognition method of claim 1, wherein the step recognizing said utterance comprising:
providing an utterance, said utterance corresponding to a feature;
for at least one portion of said feature, categorizing said Gaussians into one of M categories, wherein M is an integer, according to which of said clusters contains said Gaussian by using measurement of distance from said feature to said cluster; and
when said Gaussian is in a first of said M categories, evaluating said Gaussian for said feature, and when said Gaussian is in a second of said M categories, approximating said Gaussian for said feature according to the cluster containing said Gaussian.

5. A speech recognition method of claim 1, wherein the step recognizing said utterance comprising:
receiving a leading frame of non-speech of a received utterance;
for said leading frames, selecting a corresponding one of said N cluster which has the largest probability for observation of said leading frame;
for a subsequent frame received after said leading frame, computing a probability of observing said subsequent frame for any of said corresponding cluster; and
using said probability as adjunct to probability of background or silence model.

6. A speech recognition method of claim 1, wherein the step recognizing said utterance comprising:
receiving a leading frame of non-speech of a received utterance;
for said leading frame, selecting a corresponding one of said N cluster which has the largest probability for observation of said each leading frame;
for a subsequent frame received after said plurality of leading frames, computing a ratio of a probability of observing said subsequent frame for any of said N clusters divided by a probability of observing said subsequent frame for any of said corresponding cluster; and
using said ratio in speech detection.

7. An automatic speech recognition system, comprising:
utterance receiving mechanism;
a speech model access mechanism, said speech model includes at least a portion of a state of Gaussian; and
a computer readable medium comprising computer instructions that, when executed by a processor, causes the processor to perform a method comprising:
clustering said Gaussian of said speech model, retrieved view said speech model access mechanism, to give N clusters of Gaussian, wherein N is an integer; and
utilizing said Gaussian in recognizing said utterance, from said utterance receiving mechanism.
